(19) United States
(12) Patent Application Publication
(10) Pub. No.: US 2024/0272273 A1
(43) Pub. Date: Aug. 15, 2024

(54) Exterior Component for a Means of Transportation, Means of Transportation, and Method for Producing an Exterior Component

(71) Applicant: Bayerische Motoren Werke Aktiengesellschaft, Muenchen (DE)

(72) Inventors: Manuel SCHWARZ, Landshut (DE); Bernd VEIHELMANN, Landshut (DE)

(21) Appl. No.: 18/568,630

(22) PCT Filed: Jun. 24, 2022
(86) PCT No.: PCT/EP2022/067403

§ 371 Date: Dec. 8, 2023

(30) Foreign Application Priority Data
Jul. 19, 2021 (DE) 10 2021 118 563.7

(51) Int. Cl. G01S 7/02; G01S 13/931

(52) U.S. Cl. CPC G01S 7/027; G01S 13/931

(57) ABSTRACT

Please substitute the new Abstract submitted herewith for the original Abstract: An exterior component for a means of transportation, including a light-guiding layer, a light source, a cover layer arrangement, and a light decoupling device. The light-guiding layer is transparent at least in sections and has a depression. The light source is disposed in the depression, and is configured to couple light into the light-guiding layer. The cover layer arrangement is transparent at least in sections, on the light-guiding layer, and is configured to at least partially reflect the light coupled into the light-guiding layer. The light decoupling device is configured to decouple at least a first part of the light out of the exterior component in an area of the exterior component spaced apart from the depression, in which the exterior component is radar-transparent.

### BACKGROUND AND SUMMARY

The disclosure relates to an exterior component for a means of transportation, to a means of transportation having the exterior component, and to a method for producing such an exterior component.

Modern means of transportation, such as vehicles, for example, ground vehicles, aircraft, and water vehicles, are provided with exterior components on their outside. These exterior components can be designed, for example, as screens or covers and can protect functional components of the means of transportation from weather influences, such as sunlight, rain, or snow. A functional component of a vehicle useful in particular for a driver assistance system, such as adaptive cruise control, is a radar system.

To avoid damage to the radar sensors of the radar system due to the introduction of moisture, covering them by means of an exterior component is known from the prior art. For example, document DE 10 2018 205 739 A1 describes for this purpose a radar screen having a colored three-dimensional relief, in which three-dimensional structures up to one tenth of a radar wavelength are represented on a front of the protective plate on the basis of design elements in the color of a protective plate material. A chromium appearance is created on the basis of aluminum or tin.

Against this background, it is an object of the present disclosure to provide an exterior component for a means of transportation which is efficiently producible and enables better visibility of the means of transportation in darkness. Furthermore, it is an object to provide a means of transportation having such an exterior component and a method for producing the exterior component.

This object is achieved by an exterior component having the features disclosed herein.

The exterior component comprises a light-guiding layer which is transparent at least in sections, preferably completely, having a depression, a light source received in the depression, which is configured to couple (visible) light into the light-guiding layer, a cover layer arrangement, which is transparent at least in sections, on the light-guiding layer, which is configured to at least partially reflect the light coupled into the light-guiding layer, and a light decoupling device, which is designed to decouple at least a first part of the light in an area of the exterior component spaced apart from the depression, in which the exterior component is radar-transparent, out of the exterior component.

The exterior component can thus be brightened. In particular, it enables light to be emitted essentially in front of a radar sensor (transmitter and receiver) in order to thus provide an additional light exit surface on the means of transportation. In other words, a radar-transparent area of the exterior component can de facto emit visible light into the surroundings. The overall surface of the means of transportation emitting light into the surroundings can thus be enlarged, in order to increase the visibility of the means of transportation due to the illuminated exterior component. In addition, the exterior component designed in the above-described manner can be produced comparatively quickly, easily, and inexpensively by means of an injection-compression molding method. The pattern or the shape of the light radiated from the exterior component can synergistically be defined comparatively easily by means of the light decoupling device. The light source received in the depression can at the same time radiate light directly into the light-guiding layer, so that the latter guides the light along the light-guiding layer, and radiate light directly in the direction of a visible side of the exterior component, in order to display a defined light shape.

In this disclosure, reference is made to diverse layers. None of the layers mentioned here is necessarily to be understood as continuous or even as extending over the entire exterior component. Rather, any of these layers can be provided with recesses or passage openings, into which one or more of the other layers can optionally protrude. In other words, arbitrary ones of the layers mentioned here can be continuous or interrupted. It is sufficient that the layer is formed layered at least in one partial area of the exterior component. The layer can be flat or curved once/multiple times or can follow a predetermined contour of the exterior component. It is obvious by itself that the layers described here can have different thicknesses.

The exterior component has a front side (visible side) provided for observation and a rear side opposite to the front side. Accordingly, each element of the exterior component, in particular the light-guiding layer and the cover layer arrangement including each individual layer of the cover layer arrangement, also has a front side and a rear side. The cover layer arrangement is preferably arranged on the front side here with respect to the light-guiding layer and the light decoupling device is preferably arranged on the rear side relative to the light-guiding layer.

The light-guiding layer can be designed in particular as a (flat or curved) planar light guide. It was stated that the light-guiding layer is transparent at least in sections. Transparent can mean optically clear or translucent here. Furthermore, the light-guiding layer can be made colored or colorless. In one preferred variant, the light-guiding layer is completely transparent, in particular optically clear, so that it can guide the light essentially without damping. The light-guiding layer can have a first index of refraction which is preferably greater than 1.4 or greater than 1.45 or greater than 1.5, preferably approximately 1.58. For this purpose, the light-guiding layer can in particular be produced from a plastic (in particular polycarbonate). The light-guiding layer can be between 1 mm and 20 mm thick, preferably between 3 mm and 10 mm.

On the front side and the rear side, i.e., on the side of the cover layer arrangement and on the side of the light-guiding layer opposite to the cover layer arrangement, an index of refraction jump can be provided on the exterior component, so that the light-guiding layer guides the light along the layer by total internal reflection. For this purpose, the light source can in particular be arranged and configured so that it radiates at least the first part of the light at a predetermined angle in relation to a main extension surface of the light-guiding layer, so that the light is totally reflected at the index of refraction jump. A mirror layer can preferably be formed directly on the light-guiding layer at least in sections on the front side and/or the rear side of the light-guiding layer. The mirror layer can be metallic as a thin-film or dielectric.

The depression is preferably formed as an elongated groove in the material of the light-guiding layer. The depression can have a cross section here which essentially corresponds to a cross section of the light source, so that an inner circumferential surface of the depression/groove extends along an outer circumferential surface of the light source received in the depression. In one particularly preferred variant, the outer circumferential surface of the light source received in the depression contacts the inner circumferential surface of the depression/groove in particular directly. In other words, in this case the light source can be mounted directly on the inner circumferential surface.

The depression can in particular extend starting from the rear side of the light-guiding layer into the material of the light-guiding layer, thus can be open toward the rear side. Accordingly, the section of the light source can be inserted into the light-guiding layer from the rear side, but not from the front side. The depression can have multiple sections upon observation along the light-guiding layer, which adjoin one another or are spaced apart from one another. The sections can each be linear or curved in particular. The section of the light source received in the depression can have multiple subsections, each of which is arranged in one of the sections of the depression.

The sections of the depression can together form a pattern upon observation along the light-guiding layer. If the subsections of the light source emit a second part of the light from the depression in the direction of the front side, the pattern can be visible as a light pattern visible from the front side. The pattern or the light pattern can represent one or more shapes, images, symbols, and/or emblems. The pattern preferably comprises contour lighting extending along an in particular entire edge of the exterior component. Furthermore, the pattern can contain multiple parts, in particular lines, which can be located in the radar-transparent area of the exterior component.

Reference is made in the context of this disclosure to the light source received in the depression. However, this does not preclude one or more further light sources, which can possibly even be formed integrally with the light source designated here, being provided outside the depression. Rather, the part of an illumination device which is arranged in the depression is designated here as the light source. In other words, light can leave the illumination device from the light source.

In one preferred variant, the light source thus comprises a fiber-optic cable, which can be embedded at least in sections in the light-guiding layer viewed in the cross section. The fiber-optic cable can in particular be designed as an optical fiber or optical fiber bundle having (at least) one core and (at least) one casing. The optical fiber or the optical fiber bundle can be designed as a plastic fiber/bundle or as a quartz fiber/bundle. The optical fiber/the optical fiber bundle is preferably flexible, so that it can advantageously be bent nondestructively permanently to a bending radius of at most 15 cm or at most 10 cm or at most 5 cm or at most 2 cm or at most 1 cm or at most 0.6 cm.

The fiber-optic cable is preferably designed as a multicore fiber-optic cable. In particular, it can have multiple cores which are enclosed in a common casing. In this way, the fiber-optic cable can be constructed as mechanically flexible, on the one hand, and having a relatively large diameter, on the other hand, so that the second part of the light, with low structural height (thickness) of the exterior component, can be radiated over a significant width of the cover layer arrangement from the exterior component and is accordingly readily recognizable.

The casing can be produced, for example, from a polyolefin. The casing can be provided with a means for predefined decoupling of the light from the fiber-optic cable, in particular directly, into the light-guiding layer. A surface of the casing is preferably provided in a first section with a mirror layer, when no light is to be emitted from the fiber-optic cable via this section. The use of the light radiated into the fiber-optic cable can thus be made more efficient.

In a second section of the casing, the intensity of the light decoupled there can be defined by variation of a ratio between the index of refraction of the casing and the index of refraction of the core/the cores. In particular, in the second section, the difference between the index of refraction of the casing and the index of refraction of the core/the cores can change along the fiber-optic cable. This difference between the indices of refraction can be, in a subsection of the second section, less than 0.2 or less than 0.1 or less than 0.05 or less than 0.01. Scattering decoupling structures for decoupling light from the fiber-optic cable into the light-guiding layer can thus advantageously be omitted. However, it is also conceivable to provide such decoupling structures on the casing in a third section of the fiber-optic cable, which can decouple the second part of the light from the fiber-optic cable in the direction of the front side of the exterior component. The first, second, and third section of the fiber-optic cable can partially or completely overlap one another.

The illumination device preferably additionally comprises a light emitter, for example, in the form of a laser (in particular a diode laser) or a light-emitting diode. The light emitter can be configured to couple the light into the fiber-optic cable outside the light-guiding layer. For this purpose, the fiber-optic cable can be finished with a plug located outside the light-guiding layer. Alternatively, the light source can have one or more light-emitting diodes (LEDs), i.e., the light-emitting diode(s) can be arranged directly in the depression. The exterior component is preferably configured in multi-layered fashion, wherein in particular the cover layer arrangement is multilayered. All layers of the exterior component can be materially bonded to one another. In particular, the cover layer arrangement can be formed on the front side on the light-guiding layer. The cover layer arrangement can have a heating layer, an intermediate layer, a carrier layer, and/or a surface coating, wherein these layers are preferably arranged flatly on one another in this mentioned sequence beginning at the front-side surface of the light-guiding layer. Alternatively, the heating layer can be arranged on the rear side on the light-guiding layer. The cover layer arrangement is preferably designed as a film, in particular as a film insert for an injection molding or injection-compression molding method.

The heating layer is radar-transparent at least in sections, preferably completely. It can be configured in particular to ensure the freedom from frost of the exterior component during operation of radar sensors covered by the exterior component to avoid malfunctions of the radar sensors. For this purpose, one or more heating wires can extend in the heating layer, which have a diameter viewed in cross section of less than 1 mm or less than 0.5 mm or less than 0.2 mm. The material of the heating layer bearing the heating wires preferably has an index of refraction which corresponds to the first index of refraction. In this case, the first part of the light can propagate essentially without reflection through an interface between the light-guiding layer and the mentioned material of the heating layer.

The carrier layer is preferably provided with a pattern visible optically (with the human eye). The pattern can be implemented by a masking on the carrier layer. The masking can have translucent and opaque areas. The opaque areas are preferably designed as light absorbing and/or mirrored. The masking can contain, for example, white, multicolored, or black color particles/pigments in the opaque areas, so that the masking is visible from the front side of the exterior component to the observer when the light source does not emit light. The masking can be formed, for example, by means of printing, screen printing, film application, or coating.

The intermediate layer is preferably produced from a so-called low-refractivity material and has optically refractive properties. It is preferably configured to reflect light incident thereon from the light-guiding layer back in the direction of the light-guiding layer. For this purpose, the intermediate layer can have a second index of refraction which deviates from the first index of refraction of the light-guiding layer. The second index of refraction is preferably lower than the first index of refraction. In particular, the second index of refraction can be at most 1.5, at most 1.45, at most 1.4, or at most 1.38, preferably between 1.3 and 1.45. The first part of the light radiated into the light-guiding layer can thus be reflected with total reflection at the rear-side surface of the intermediate layer, i.e., at the interface between the heating layer and the intermediate layer, back in the direction of the light-guiding layer.

The light source/the fiber-optic cable is most preferably finished so that the first part of the light is incident on the rear-side surface of the intermediate layer at an angle which is less than the total reflection angle at the interface between the heating layer and the intermediate layer. Preferably, a third surface area of the light source, at which essentially no light leaves the light source, is arranged between a first surface area in the circumferential direction of the light source, at which the first part of the light leaves the light source, and a second surface area in the circumferential direction of the light source, at which the second part of the light leaves the light source. The intermediate layer can be produced from a plastic, in particular polymethyl methacrylate (PMMA) or polycarbonate (PC).

The surface coating preferably forms the front-side outer surface of the exterior component and is therefore formed on a surface of the cover layer arrangement facing away from the light-guiding layer. The surface coating is preferably used as a protective layer. It can in particular have a hardness which is greater than a hardness of the carrier layer, the intermediate layer, the heating layer, and/or the light-guiding layer. The surface coating is preferably produced from a plastic (in particular polyurethane).

The light decoupling device can decouple light from the exterior component in the direction of the front side. In one preferred variant, the light decoupling device is arranged on an outer surface of the light-guiding layer, so that the light-guiding layer can be produced completely transparently and nonetheless comparatively easily by injection molding/injection-compression molding. In particular, the light decoupling device can be formed on the rear-side surface of the light-guiding layer. The light decoupling device preferably comprises light-scattering elements which, upon imagined projection of the masking perpendicular to the light-guiding layer on the rear side of the light-guiding layer, are arranged in the projected translucent areas.

The means of transportation proposed here can in particular be a vehicle, for example, an electric vehicle or a land vehicle, and has an exterior component described in detail above. The means of transportation preferably comprises a radar system configured to emit radar waves. The exterior component can be arranged on the means of transportation such that the radar waves are in particular incident on the rear side of the exterior component on the radar-transparent area thereof. The exterior component can thus form a screen or a cover of an emitting and/or receiving unit of the radar system, through which the radar waves can propagate, while light exits in the direction of the observer on the front side from the exterior component.

In one preferred variant, the exterior component is provided in the area of a front or a rear of the means of transportation, so that the exterior component is externally visible. In particular, the exterior component can be arranged on the front side on the vehicle above or below or as part of the front hatch, for example the central area below the front hatch. The exterior component can be used as a decorative element, cover, and/or decorative trim.

The method for producing the exterior component can comprise at least one injection-compression molding process by means of an injection-compression molding device. The injection-compression molding process preferably comprises the following steps, which can be carried out in particular in the sequence mentioned hereinafter: inserting the cover layer arrangement, which is transparent at least in sections, as an insert into an injection-compression molding tool of the injection-compression molding device, wherein the injection-compression molding tool has a first tool cover; injecting a first molding compound into a cavity of the injection-compression molding tool, while the injection-compression molding tool is incompletely closed; closing a gate of the injection-compression molding device to prevent the first molding compound from flowing back out of the cavity; and compressing the first molding compound to bond the transparent light-guiding layer to the cover layer arrangement.

The cover layer arrangement is preferably formed in this case without the surface coating. In contrast, it can comprise the heating layer, the intermediate layer, and/or the carrier layer at this time. The cover layer arrangement is preferably provided as a film insert for this injection-compression molding process and is positioned with the front side on an inner surface of the injection-compression molding tool. The cover layer arrangement is thus practically back-injected to mold on the light-guiding layer.

An injection molding process following the injection-compression molding process for reactive injection molding preferably comprises the following steps, which can be carried out in particular in the sequence mentioned hereinafter: removing the first tool cover of the injection-compression molding tool after the injection-compression molding process; putting on a second tool cover of the injection-compression molding tool; flooding the cavity of the injection-compression molding tool with a second molding compound to form the surface coating of the cover layer arrangement, wherein the second molding compound contains two (or more) components.

Alternatively to the injection molding process, the surface coating of the cover layer arrangement can be formed by a lacquering process on the carrier layer having the masking. The depression of the light-guiding layer can advantageously already be formed in the injection-compression molding process by a corresponding projection in the injection-compression molding tool. Alternatively, the depression can be introduced later, for example, by milling.

The terms “comprising”, “including”, “having”, and the like used in this disclosure are to be understood as nonexhaustive. In particular, the term “comprising a” in this context means “comprising at least one”, i.e., “comprising a” does not preclude further corresponding elements being present. For example, the terms “comprising a light-guiding layer”, “comprising a light source”, and “having a depression” are to be understood to mean that the exterior component can have one or more light-guiding layers and one or more light sources and the light-guiding layer can have one or more depressions.

Preferred embodiments of an exterior component for a means of transportation, the means of transportation, and a method for producing the exterior component will now be explained in more detail with reference to the appended schematic drawings, in which:

### BRIEF DESCRIPTION OF THE DRAWINGS

FIG. 1 shows an embodiment of an exterior component in a cross-sectional view;

FIG. 2 shows an embodiment of an exterior component in a front view;

FIG. 3 shows an embodiment of a means of transportation having the exterior component, wherein the exterior component is arranged in the area of the front of the means of transportation; and

FIG. 4 shows an embodiment of a method for producing the exterior component.

### DETAILED DESCRIPTION OF THE DRAWINGS

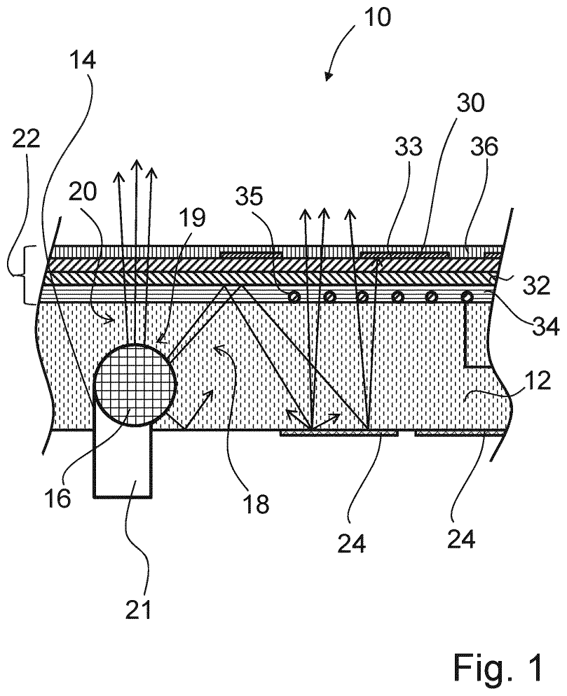

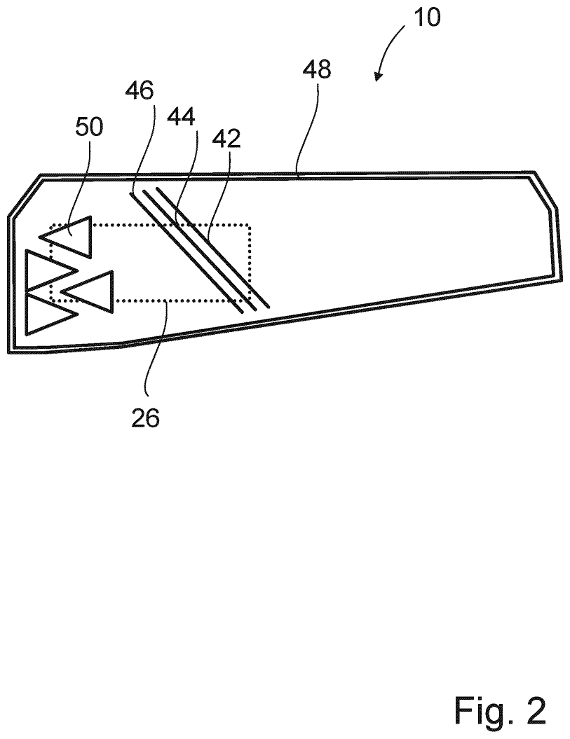

FIGS. 1 and 2 show an exterior component 10 for a means of transportation 100. The exterior component 10 is a screen for a radar sensor of a radar system and the means of transportation is a motor vehicle, for example, an electric vehicle here. The exterior component 10 is constructed in multiple layers and comprises, beginning at a rear side of the exterior component 10 located at the bottom in FIG. 1, a transparent light-guiding layer 12 and a cover layer arrangement 22, wherein the cover layer arrangement 22 has, from the rear side in the direction of the front side of the exterior component 10 located at the top in FIG. 1, a heating layer 34, an intermediate layer 32, a carrier layer 30 having a masking 33, and a surface coating 36. The surface coating 36 forms a protective layer on the front side of the exterior component 10 and is preferably produced from a plastic (in particular polyurethane). Adjacent ones of these layers are materially bonded to one another.

The light-guiding layer 12 is provided with a depression 14, into which a light source 16 in the form of a fiber-optic cable having multiple cores and common casing is inserted. The depression 14 comprises multiple depression sections 42, 44, 46, 48, into each of which a corresponding light source section is inserted. The depression sections 42, 44, 46, 48 shown in FIG. 2 comprise a contour groove 48 extending in the light-guiding layer along an outer circumference of the exterior component 10 and a groove pattern (in the form of three elongated grooves 42, 44, 46 parallel to one another here) formed in a radar-transparent area 26 of the exterior component 10. The exterior component 10 is radar-transparent in the radar-transparent area 26 through its layers, i.e., it damps radar waves in the propagation direction to a negligible extent.

Statements made hereinafter for the light source 16 and the depression 14 apply to each of their sections. The light source 16/the fiber-optic cable, in particular the casing of the fiber-optic cable, is in direct contact with the light-guiding layer 12, which is configured to guide a first part 18 and a second part 20 of the light coupled from the light source 16 into the light-guiding layer 12 in the interior of the light-guiding layer material. For this purpose, a medium (here: air) having an index of refraction which is lower than the index of refraction of the light-guiding layer 12 (here: light-guiding layer 12 made of a plastic (polycarbonate having index of refraction 1.58 here)) adjoins on the rear side of the light-guiding layer 12. The material enclosing heating wires 35 of the heating layer 34 has essentially the same index of refraction as the light-guiding layer 12. On the front side, the light guiding along the light-guiding layer 12 thus takes place due to total reflection at an interface between the light-guiding layer 12 and the intermediate layer 32, wherein the intermediate layer 32 is made of a material having low index of refraction (approximately 1.3 here). The heating wires 35 have a cross section having a diameter of less than 3 mm.

The casing of the fiber-optic cable of the light source 16 is finished along its outer circumferential surface with means for predefined decoupling of the light, which delimit the exit of the first part 18 of the light and second part 20 of the light viewed in cross section through the light source 16 to an associated first or second angle range in each case. A (totally) reflective area 19 is arranged between the first and the second angle range, in which essentially no light exits from the fiber-optic cable. In a rear-side area of the fiber-optic cable, it is mirrored and is provided by means of a holding element 21. The second angle range extends over at most 20°, preferably at most 10°, most preferably at most 5°. In this way, defined lines or contours can be optically represented (so-called line light). The first angle range, in which the first part 18 of the light propagates out of the fiber-optic cable, extends only over angles relative to the main extension direction of the light-guiding layer 12 at which the first part 18 of the light can experience total reflection at the rear-side surface of the intermediate layer 32 (see propagation of the first part 18 of the light in FIG. 1).

The masking 33 of the carrier layer 30 comprises opaque areas, which preferably form a pattern which is optically visible when the light source 16 does not emit light. As shown in FIG. 2, the pattern can be a background for a light pattern 50 (a jagged pattern here, for example), which can be represented by means of the first part 18 of the light on the exterior component 10. To be able to decouple the first part 18 of the light flatly in the form of a so-called surface light, in particular the above-mentioned light pattern, at a point remote from the light source 16 along the light-guiding layer 12, in particular in the radar-transparent area 26, out of the light-guiding layer 12 and out of the exterior component 10 at the front side of the exterior component 10, the exterior component 10 furthermore comprises a light decoupling device 24. The light decoupling device 24 is formed by light-scattering elements (for example, prisms, embossings, microstructures having optical units, or lacquer) on the rear-side surface of the light-guiding layer. In a front view of the exterior component 10, the light-scattering elements are visible through translucent areas of the masking 33 complementary to the opaque areas.

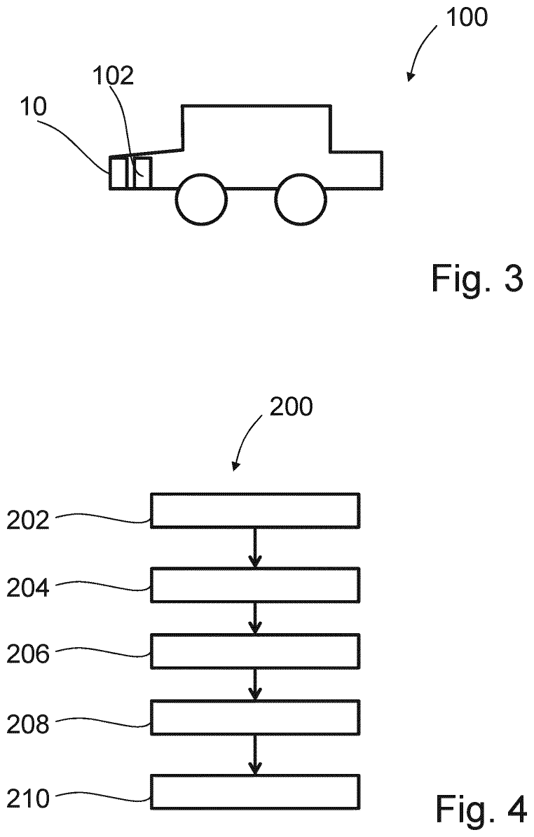

The means of transportation 100 is schematically shown in FIG. 3 and has a radar system 102, the radar sensors of which (in particular emitter and receiver of the radar waves) are arranged in the longitudinal direction of the means of transportation behind the exterior component 10. The radar waves emitted by the radar sensors propagate from the rear side of the exterior component 10 in the direction of the front side when they leave the radar system 102.

The exterior component 10 can be produced in particular by means of a method 200 schematically shown in FIG. 4, which in this case comprises an injection-compression molding process and a reactive injection molding process. The injection-compression molding process comprises the following steps: inserting 202 the cover layer arrangement 22 as an insert into an injection-compression molding tool, having a first tool cover, of the injection-compression molding device; injecting 204 a molding compound into a cavity of the injection-compression molding tool while the injection-compression molding tool is incompletely closed; closing 206 a gate of the injection-compression molding device to prevent the molding compound from flowing back out of the cavity; and compressing 208 the molding compound to bond the transparent light-guiding layer 12 to the cover layer arrangement 22.

In addition, the method 200 can comprise the reactive injection molding process 210 after the step of compression 208, wherein during the process 210, the first tool cover of the injection-compression molding tool is exchanged after the injection-compression molding process for a second tool cover. Subsequently, the cavity of the injection-compression molding tool is flooded using a further molding compound having two components, in order to form the surface coating of the cover layer arrangement quickly and easily.

1-10. (canceled)

11. An exterior component for a means of transportation, comprising:
a light-guiding layer, which is transparent at least in sections, having a depression;
a light source disposed in the depression, which is configured to couple light into the light-guiding layer;
a cover layer arrangement, which is transparent at least in sections, on the light-guiding layer, which is configured to at least partially reflect the light coupled into the light-guiding layer; and
a light decoupling device, which is configured to decouple at least a first part of the light out of the exterior component in an area of the exterior component spaced apart from the depression, in which the exterior component is radar-transparent.

12. The exterior component according to claim 11, wherein
the light-guiding layer has an index of refraction which is greater than 1.4 or greater than 1.45 or greater than 1.5, and/or
the light-guiding layer is produced from polycarbonate.

13. The exterior component according to claim 12, wherein
the light source has a fiber-optic cable having at least one core and at least one casing, and
the fiber-optic cable is embedded at least in sections in the light-guiding layer.

14. The exterior component according to claim 13, wherein
the at least one casing is provided with a means for predefined decoupling of the light out of the fiber-optic cable into the light-guiding layer.

15. The exterior component according to claim 14, wherein
the cover layer arrangement is materially bonded to the light-guiding layer.

16. The exterior component according to claim 15, wherein
the cover layer arrangement has a carrier layer having an optically visible pattern, and/or
the cover layer arrangement has an intermediate layer, which is configured to reflect light incident on the intermediate layer from the light-guiding layer back in the direction of the light-guiding layer.

17. The exterior component according to claim 16, wherein
the cover layer arrangement has a heating layer, which is radar-transparent at least in sections, and/or
the cover layer arrangement has a surface coating, which is formed on a surface of the cover layer arrangement facing away from the light-guiding layer.

18. The exterior component according to claim 17, wherein
the light decoupling device is formed at a point of the light-guiding layer opposite to the cover layer arrangement, and/or
the cover layer arrangement is formed as a film.

19. A means of transportation having an exterior component according to claim 18, wherein
the means of transportation is a vehicle, and/or
the means of transportation has a radar system, which is configured to emit radar waves, and the exterior component is arranged on the means of transportation such that the radar waves are incident on the radar-transparent area of the exterior component.

20. A method for producing an exterior component for a means of transportation according to claim 18, comprising at least one injection-compression molding process by means of an injection-compression molding device, wherein the injection-compression molding process comprises the following steps:
inserting (the cover layer arrangement, which is transparent at least in sections, as an insert into an injection-compression molding tool of the injection-compression molding device;
injecting a molding compound into a cavity of the injection-compression molding tool while the injection-compression molding tool is incompletely closed;
closing a gate of the injection-compression molding device to prevent the molding compound from flowing back out of the cavity; and
compressing the molding compound to bond the transparent light-guiding layer to the cover layer arrangement.
